(19) United States
(12) Patent Application Publication
(10) Pub. No.: US 2025/0031910 A1
(43) Pub. Date: Jan. 30, 2025

(54) Vegetable Dehydrator

(71) Applicant: Kitchen Brights Limited, Hong Kong (CN)

(72) Inventor: Kwan Ming Cheng, Hong Kong (CN)

(21) Appl. No.: 18/619,175

(22) Filed: Mar. 28, 2024

(30) Foreign Application Priority Data
Jul. 27, 2023 (CN) 2023219974626

(51) Int. Cl. A47J 43/24; F16D 55/02; F26B 5/08

(52) U.S. Cl. CPC A47J 43/24; F16D 55/02; F26B 5/08

(57) ABSTRACT

The present invention discloses a vegetable dehydrator, which includes a barrel body and an upper cover, wherein the upper cover is detachably engaged with a top of the barrel body, a dehydration basket and a separator plate are provided between the barrel body and the upper cover, a top of the dehydration basket is clamped and fixed with the separator plate, and a center of an inner bottom surface of the barrel body is provided with a limiting protrusion which supports and makes the dehydration basket to rotate freely on a tip of the limiting protrusion. According to the present invention, a knob and a driving mechanism are provided, hands are released after the knob is twisted, and a buckle fixed above the dehydration basket is driven by gears due to a tension of a tension spring, so that the dehydration basket can rotate.

This application claims the priority to and the benefit of Chinese Utility Model Application No. 2023219974626 filed on Jul. 27, 2023, the entire contents and disclosures of which are hereby incorporated by reference into this application

### TECHNICAL FIELD

The present invention relates to the technical field of vegetable draining devices, in particular to a vegetable dehydrator.

### BACKGROUND

At present, after vegetables are cleaned by household kitchen utensils, vegetables are usually placed in a draining basket so as to be automatically drained and dried, which is time-consuming in drainage and not good in drainage effect.

Chinese patent CN104367212B discloses an electric food dehydrator, which includes a main body, a through hole food basket, a connecting inner cover, an upper cover component, a rotating power component and a detachable power supply component; the through hole food basket is placed inside the main body, the connecting inner cover is installed on the upper part of the through hole food basket through a detachable structure, the upper cover component covers the upper part of the main body, the rotating power component is provided on the upper cover component, the rotating power component is drivingly connected with the connecting inner cover, and the detachable power supply component is connected with the rotating power component; the rotating power component is provided with an air inlet, the connecting inner cover is provided with a fan blade structure, and the upper cover component is provided with an air outlet. The electric food dehydrator is driven by a motor to rotate and is provided with a micro-heating blowing function and an up-and-down vibration function, which increases the dehydration effect and is more convenient to use.

The device is electrically driven to drain vegetables, a motor component at the top is heavy, and the upper end of the device occupies a large space, which is not convenient to carry out for a picnic.

### SUMMARY

The purpose of the present invention is to provide a vegetable dehydrator, so as to solve the problems in the prior art mentioned in the background that the device is electrically driven to drain vegetables, the motor component at the top is heavy, and the upper end of the device occupies a large space, which is not convenient to carry out.

In order to achieve the above purpose, the present invention provides the following technical scheme: a vegetable dehydrator, including a barrel body and an upper cover, wherein the upper cover is detachably engaged with a top of the barrel body, a dehydration basket and a separator plate are provided between the barrel body and the upper cover, a top of the dehydration basket is clamped and fixed with the separator plate, a center of an inner bottom surface of the barrel body is provided with a limiting protrusion which supports and makes the dehydration basket to rotate freely on a tip of the limiting protrusion, a bottom of the dehydration basket is provided with a limiting groove into which the limiting protrusion is inserted, a buckle is fixed on an upper surface of the separator plate, a driving mechanism which drives the buckle to rotate is provided below the upper cover, a knob is rotatably connected in the upper cover, and a hook is fixed on an outer wall of the knob;

The driving mechanism includes an installation disk, a tension spring and a center gear, the installation disk is fixed below the upper cover, one end of the tension spring is fixedly connected with an inner wall of the installation disk, the other end of the tension spring is hooked with the hook, and the buckle is coaxially attached to the center gear.

Preferably, the driving mechanism includes a sector gear, a driving gear and a driven gear, the sector gear is coaxially attached to the bottom of the knob, the driving gear is meshed with the sector gear, the driven gear and the driving gear are coaxially attached to each other.

In one embodiment, the driving mechanism further comprises a slotted groove wherein the slotted groove is a longitudinal slot configured to receive a common axle penetrating through a center of the driven gear and the driving gear so that the driving gear and the driven gear can slide along the slotted groove.

In one embodiment, the knob is configured to be twisted such that the rotation of the sector gear makes the driving gear rotate and forces the driven gear away from the center gear based on the shape of the slotted groove and the center gear does not mesh with the driven gear; wherein the knob is configured to be released such that the rotation of the sector gear makes the driving gear rotate reversely and therefore forces the driven gear to move to the center gear based on the shape of the slotted groove and the center gear meshes with the driven gear, whereby the driving mechanism is configured to rotate the buckle and the dehydration basket when the knob is released and the driving mechanism is configured not to rotate the buckle and the dehydration basket when the knob is twisted.

In one embodiment, the knob is configured to be twisted to any degree and released. In another embodiment, the knob is configured to be twisted any degree up to 120 degrees and released. In another embodiment, the knob is configured to be twisted any degree up to 90 degrees and released. In another embodiment, the knob is configured to be twisted any degree up to 60 degrees and released.

Preferably, the driving mechanism further includes a limiting plunger and a stopper, the stopper is configured to block the limiting plunger from moving beyond the stopper, the limiting plunger is fixed on one side of the hook and the stopper is provided on a lower surface of the upper cover.

In one embodiment, the stopper blocks the limiting plunger from moving beyond a certain angle. In another embodiment, the certain angle is 120 degrees or below. In another embodiment, the certain angle is 90 degrees or below.

Preferably, the vegetable dehydrator comprises a brake structure comprising a pressing rod, the pressing rod penetrates through the upper cover in sequence, a limiting convex ring is fixed on an outer wall of one end of the pressing rod, a limiting cylinder is fixed in the installation disk, and the pressing rod is inserted into the limiting cylinder and penetrates through the installation disk, the dehydration basket is configured to stop rotating by friction between the separator plate and a bottom end of the pressing rod when the pressing rod is pressed.

Preferably, the top of the pressing rod is provided in a hemispherical shape, and an upper surface of the upper cover is provided with a through hole through which a top end of the pressing rod penetrates.

Preferably, the vegetable dehydrator further comprises an anti-skid pad fixed at the bottom of the barrel body, and the anti-skid pad is provided in a ring shape.

Preferably, the brake structure is provided in the upper cover.

In one embodiment, the center gear is configured to push the driven gear away from the center gear based on the shape of the slotted groove after the knob is released and rotated reversely, thereby the center gear does not mesh with the driven gear and the dehydration basket can continue to freely rotate by inertia, thus prolonging hydro-extracting time.

In one embodiment, the knob is configured to be twisted and released during a free rotation of the dehydration basket that the rotation of the sector gear makes the driving gear rotate reversely and therefore forces the driven gear to move to the center gear based on the shape of the slotted groove, and the center gear meshes with the driven gear, thereby the rotation of the sector gear makes the center gear and the dehydration basket rotate further.

In one embodiment, the center gear and the rotation basket is configured to rotate further to prolong the duration of the free rotation of the dehydration basket and/or to increase the speed of the free rotation of the dehydration basket.

Compared with the prior art, the present invention has the following beneficial effect.

According to the present invention, a knob and a driving mechanism are provided, hands are released after the knob is twisted, and a buckle fixed above the dehydration basket is driven by two gears under the pull of resetting a tension spring, so that the dehydration basket can finally rotate. The vegetable dehydrator imitates a dehydration method of a washing machine, throws out water on vegetables by a centrifugal force and stores water in the barrel body. This method will not result in the problem of a poor drainage effect of vegetables at the bottom, and vegetables can be dehydrated by manually twisting and releasing the knob without additional driving, which is convenient to use. The design of the knob at the top makes the device lower in height and lighter in weight, which is convenient to carry out.

### BRIEF DESCRIPTION OF THE DRAWINGS

FIG. 1 is an exploded diagram of the present invention.

FIG. 2 is a structural schematic diagram of an upper cover and a bottom of a dehydration basket according to the present invention.

FIG. 3 is a structural schematic diagram of the upper cover and the bottom of the dehydration basket according to the present invention.

FIG. 4 is a structural schematic diagram of a knob according to the present invention.

FIG. 5 is a structural schematic diagram of a driving mechanism according to the present invention.

FIG. 6 is an isometric view of the present invention.

FIG. 7 is a schematic diagram of the cooperation between a brake structure and a dehydration basket according to the present invention.

FIG. 8 is a structural diagram of a barrel body according to the present invention.

FIG. 9 is a structural schematic diagram of the driving mechanism according to the present invention.

In the figures: 1. Barrel body; 2. Upper cover; 3. Dehydration basket; 4. Separator plate; 5. Limiting protrusion; 6. Limiting groove; 7. Buckle; 8. Driving mechanism; 9. Knob; 10. Hook; 11. Brake structure; 801. Installation disk; 802. Tension spring; 803. Center gear; 804. Sector gear; 805. Driven gear; 806. Driving gear; 807. Limiting plunger; 808. Stopper; 1101. Pressing rod; 1102. Limiting convex ring; 1103. Limiting cylinder; 1104. Through hole; 12. Anti-skid pad.

### DETAILED DESCRIPTION OF THE INVENTION

The technical scheme in the embodiment of the present invention will be clearly and completely described with reference to the attached drawings hereinafter. Obviously, the described embodiments are only some of the embodiments of the present invention, rather than all of the embodiments. Based on the embodiments in the present invention, all other embodiments obtained by those skilled in the art without creative labor belong to the scope of protection of the present invention.

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including” or “containing” is replaced with “consisting essentially of” or “consisting of”. These alternate embodiments that use “consisting of” or “consisting essentially of” are understood to be narrower embodiments of the “comprising”, “including,” or “containing,” embodiments.

For the sake of clarity, “comprising”, “including”, “containing” and “having”, and any related forms are open-ended terms which allow for additional elements or features beyond the named essential elements, whereas “consisting of” is a closed end term that is limited to the elements recited in the claim and excludes any element, step, or ingredient not specified in the claim.

It is to be understood that terms such as “top”, “bottom”, “middle”, “side”, “length”, “inner”, “outer”, “interior”, “exterior”, “outside”, “vertical”, “horizontal” and the like as may be used herein, merely describe points of reference and do not limit the present invention to any particular orientation or configuration. Further, terms such as “first,” “second,” “third,” etc., merely identify one of a number of portions, components, and/or points of reference as disclosed herein and likewise do not limit the present invention to any particular configuration or orientation.

As used herein and in the claims, the term “twisted” means the knob is rotated clockwise or counterclockwise in a way that the tension spring is stretched so that the stretched tension spring has sufficient tension to reversely rotate the knob when the knob is released.

As used herein and in the claims, the term “released” means withdrawing all the external force on the knob after the knob is twisted. In some embodiments, after the knob is released, the knob is forced to be rotated due to the pulling force of the tension spring.

As used herein and in the claims, the term “reversely rotated” or “rotated reversely” means the knob is rotated in the opposite direction to the direction of “twisted” mentioned above. According to the embodiment of the invention, this reverse rotation is driven by the pulling force of the tension spring.

### EXAMPLES

Provided herein are examples that describe in more detail certain embodiments of the present disclosure. The examples provided herein are merely for illustrative purposes and are not meant to limit the scope of the invention in any way. All references given below and elsewhere in the present application are hereby included by reference.

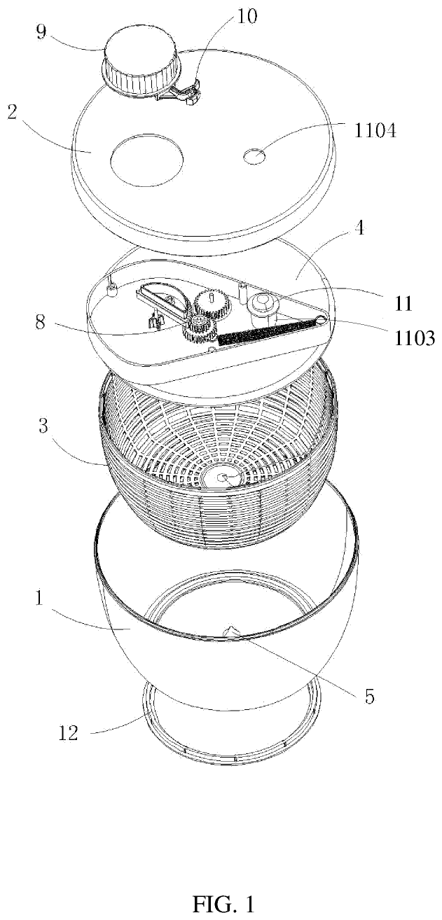

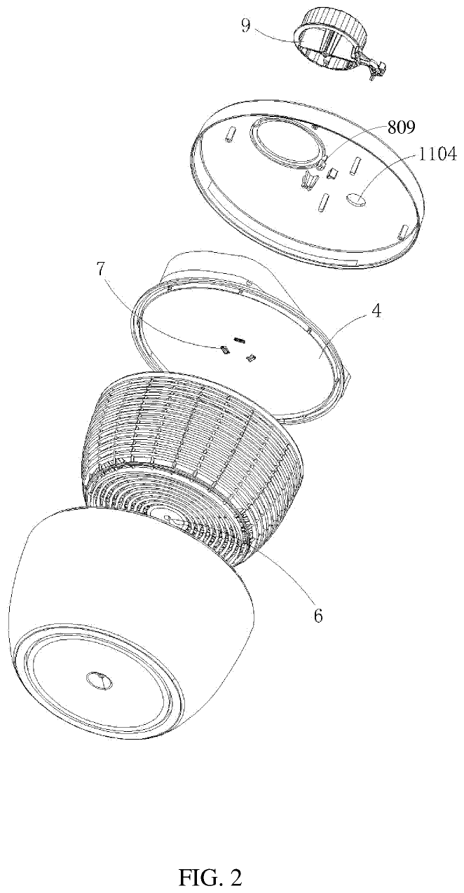

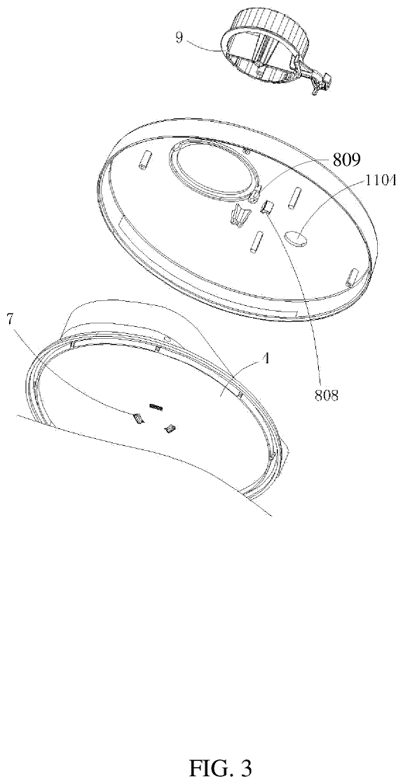

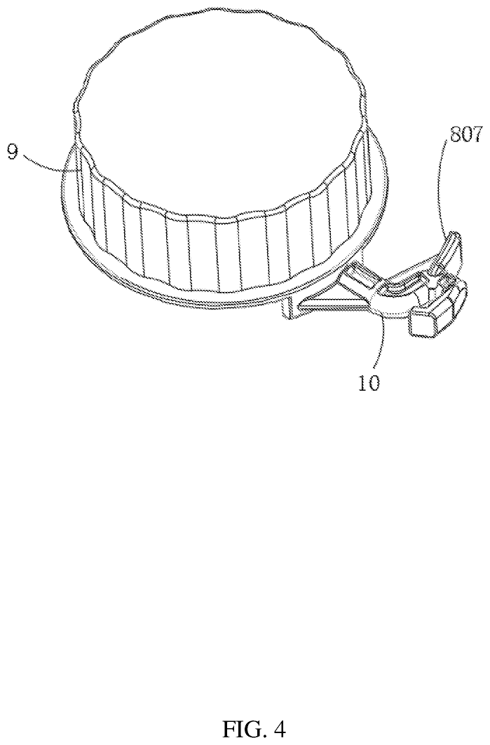

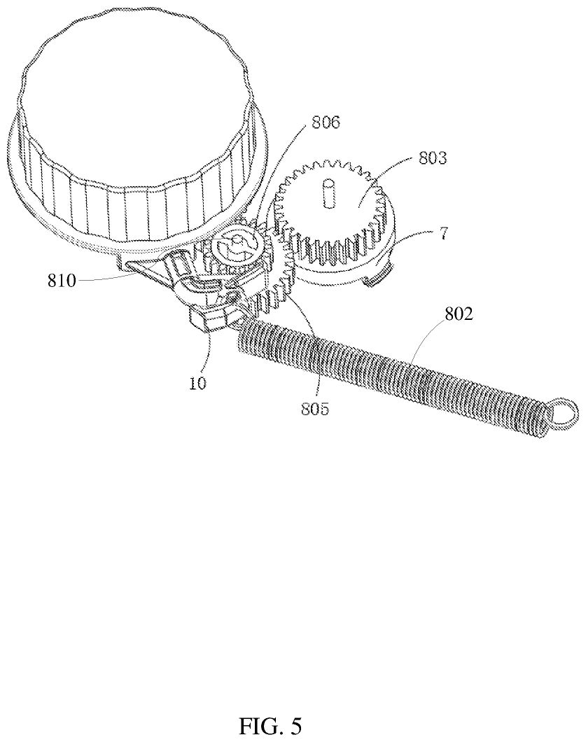

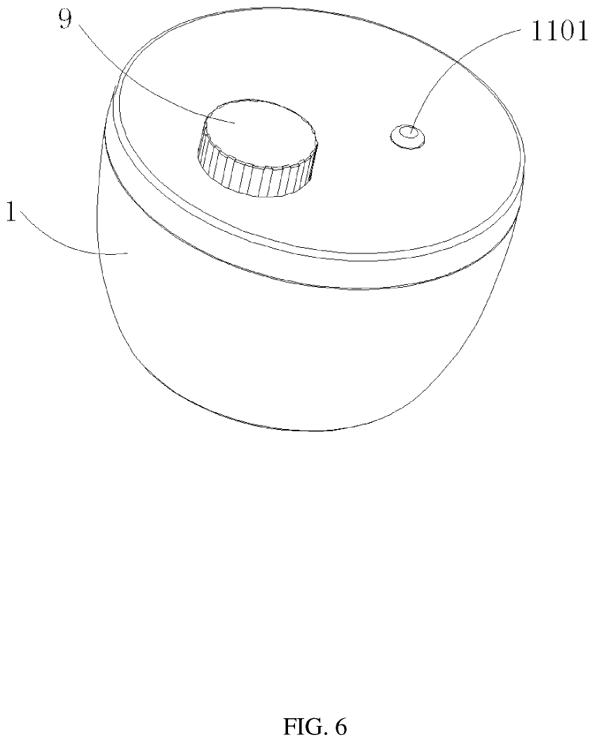

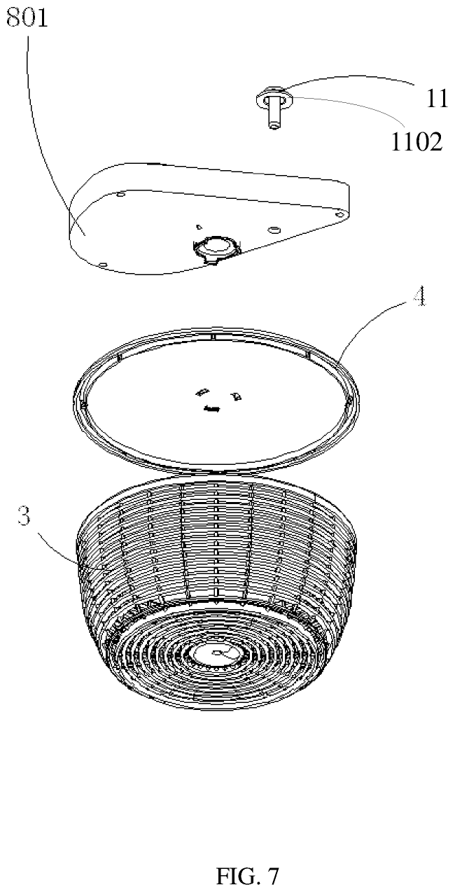

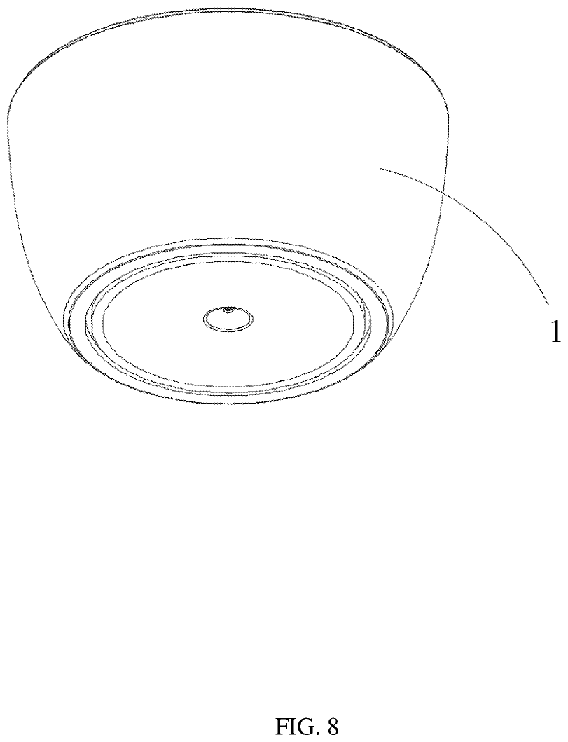

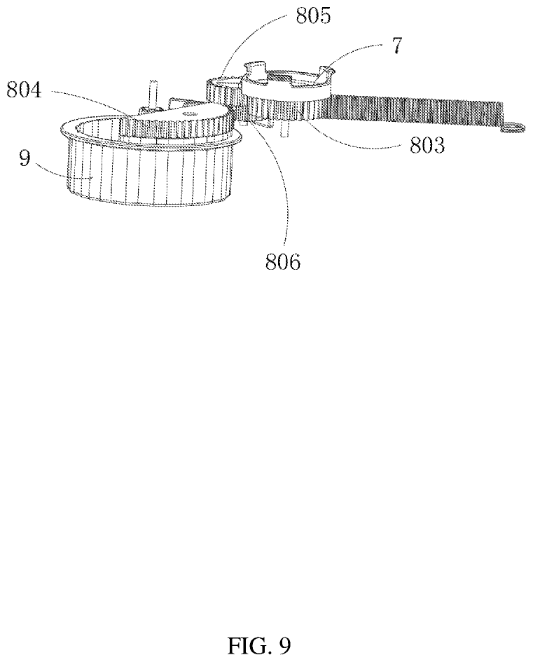

Referring to FIGS. 1 to 9, the present invention provides a technical scheme. A vegetable dehydrator includes a barrel body 1 and an upper cover 2. A dehydration basket 3 and a separator plate 4 are provided between the barrel body 1 and the upper cover 2. A middle part of an inner cavity of the barrel body 1 is provided with a limiting protrusion 5 which facilitates the dehydration basket 3 to rotate. A bottom of the dehydration basket 3 is provided with a limiting groove 6 into which the limiting protrusion 5 is inserted. A buckle 7 is fixed on an upper surface of the separator plate 4. A driving mechanism 8 which drives the buckle 7 to rotate is provided below the upper cover 2. A knob 9 is rotatably connected in the upper cover 2. A hook 10 is fixed on an outer wall of the knob 9. A brake structure 11 which stops the rotation of the dehydration basket 3 is provided in the upper cover 2.

In one embodiment, the upper cover 2 is detachably engaged with the barrel body 1. The upper cover 2 may be engaged with the barrel body 1 by one of the following methods: snap-fit, thread fit, hinges, clamps, or the like. The upper cover 2 is clamped and fixed on top of the barrel body 1.

In some embodiments, the separator plate 4 is detachably engaged with the dehydration basket 3. The separator plate 4 may be engaged with the dehydration basket 3 by one of the following methods: snap-fit, thread fit, hinges, clamps, or the like. The top of the dehydration basket 3 is clamped and fixed with the separator plate 4.

In some embodiments, the limiting protrusion 5 is formed at the center of the inner bottom surface of the barrel body 1. A tip of the limiting protrusion 5 may be conical in shape such that the tip of the limiting protrusion 5 supports and makes the dehydration basket 3 to rotate freely on the tip of the limiting protrusion 5. The shape of the limiting groove 6 is configured to match the tip of the limiting protrusion 5.

The driving mechanism 8 includes an installation disk 801, a tension spring 802, a center gear 803, a sector gear 804, a driven gear 805 and a driving gear 806. In some embodiments, the center gear 803 is coaxially provided with the buckle 7. The installation disk 801 is fan-shaped, and is fixedly connected with the upper cover 2 by screws and encloses an accommodating cavity.

In one embodiment, the installation disk 801 accommodates the driving assembly 8 within its cavity. One end of the tension spring 802 is fixedly connected with an inner wall of the installation disk 801, and the other end of the tension spring 802 is hooked with the hook 10. If the knob 9 is twisted, the tension spring 802 is configured to be stretched, creating tension in the tension spring 802. If the knob 9 is released, the knob 9 is configured to be rotated back due to the tension of the tension spring 802.

In one embodiment, the driven gear 805 and the driving gear 806 are coaxially attached to each other such that the driven gear 805 and the driving gear 806 rotate together along with a common axle 810 and are rotatably mounted on a slotted groove 809 of the driving mechanism 8. The slotted groove 809 is a longitudinal slot configured to receive the common axle 810 penetrating through a center of the driven gear 805 and the driving gear 806 so that the driven gear 805 and the driving gear 806 can slide along the slotted groove 809. The driving gear 806 is configured to mesh with the sector gear 804, and the driven gear 805 is configured to mesh with the center gear 803.

In one embodiment, the sector gear 804 is a partial gear and coaxially attached to the bottom of the knob 9. When the knob 9 is twisted, the rotation of the sector gear 804 makes the driving gear 806 rotate and forces the driven gear 805 away from the center gear 803 based on the shape of the slotted groove 809 such that the center gear 803 does not mesh with the driven gear 805. When the knob 9 is released, the rotation of the sector gear 804 makes the driving gear 806 rotate reversely and therefore forces the driven gear 805 to move to the center gear 803 based on the shape of the slotted groove 809 such that the center gear 803 meshes with the driven gear 805. As such, when the knob 9 is released, the rotation of the sector gear 804 makes both the driving gear 806 and the driven gear 805 rotate, thereby making the center gear 803 rotate.

In one embodiment, the knob 9 is configured to be twisted to any degree and released. In some embodiments, the knob 9 is configured to be twisted any degree up to 120 degrees and released. In some embodiments, the knob 9 is configured to be twisted any degree up to 90 degrees and released. In some embodiments, the knob 9 is configured to be twisted any degree up to 60 degrees and released.

In one embodiment, the center gear 803 is rotatably disposed on the inner surface of the upper cover 2. The buckle 7 is attached coaxially to the center gear 803. The buckle 7 is configured to engage with the recesses formed on the separator plate 4 such that if the buckle 7 is rotated, the separator plate 4 is also rotated. Since the separator plate 4 and the dehydration basket 3 are configured to be attached to each other, the rotation of the center gear 803 makes the dehydration basket 3 rotate accordingly.

According to the device, after the knob 9 is twisted and released, the dehydration basket 3 is rotated by means of the pulling force of the tension spring 802, thus enabling the dehydration of vegetables in the dehydration basket 3. Once the dehydration basket 3 is rotated, the dehydration basket 3 can continue to rotate by inertia, thus prolonging the hydro-extracting time.

In one embodiment, after the knob 9 is released and the knob 9 is rotated reversely back to its original angle, the center gear 803 pushes the driven gear 805 away from the center gear 803 based on the shape of the slotted groove 809 such that the center gear 803 does not mesh with the driven gear 805. As such, the center gear 803 and the dehydration basket 3 can continue to freely rotate by inertia, thus prolonging the hydro-extracting time.

In one embodiment, during the free rotation of the dehydration basket 3, knob 9 can be twisted and released, such that the rotation of the sector gear 804 makes the driving gear 806 rotate reversely and therefore forces the driven gear 805 to move to the center gear 803 based on the shape of the slotted groove 809, and the center gear 803 meshes with the driven gear 805. As such, the rotation of the sector gear 804 makes both the driving gear 806 and the driven gear 805 rotate, thereby facilitating the center gear 803 to rotate further. This twist and release of the knob 9 during the free rotation of the dehydration basket 3 can prolong the duration of the free rotation of the dehydration basket 803 and/or increase the speed of the free rotation of the dehydration basket 803.

The driving mechanism further includes a limiting plunger 807 and a stopper 808. The limiting plunger 807 is on one side of the hook 10. The stopper 808 is configured to block the limiting plunger 807 from moving beyond the stopper 808. The limiting plunger 807 is formed on one side of the hook 10, and the stopper 808 is provided on the inner surface of the upper cover 2.

In one embodiment, the stopper 808 is a slot into which the limiting plunger 807 is inserted. In one embodiment, the stopper 808 is a protrusion that prevents the movement of the limiting plunger 807.

Since the limiting plunger 807 is on one side of the hook 10 and blocked by the stopper 808, when the knob 9 is twisted, the knob 9 cannot be twisted further than a certain angle. In one embodiment, the certain angle is any angle between 0 and 360 degrees. In some embodiments, the certain angle is 120 degrees or less. In some embodiments, the certain angle is 90 degrees or less. In some embodiments, the angle is 60 degrees or less.

A brake structure 11 includes a pressing rod 1101, limiting convex ring 1102, limiting cylinder 1103 and limiting cylinder 1104. The pressing rod 1101 penetrates through the upper cover 2 in sequence. A limiting convex ring 1102 is fixed on an outer wall of one end of the pressing rod 1101. A limiting cylinder 1103 is fixed in the installation disk 801. The pressing rod 1101 is inserted into the limiting cylinder 1103 and penetrates through the installation disk 801.

The top of the pressing rod 1101 is provided in a hemispherical shape, and an upper surface of the upper cover 2 is provided with a through hole 1104 through which a top end of the pressing rod 1101 penetrates. The pressing rod 1101 is provided, so that after manually pressing the pressing rod 1101, the dehydration basket 3 stops rotating by the friction between the bottom end of the pressing rod 1101 and the separator plate 4.

An anti-skid pad 12 is fixed at the bottom of the barrel body 1, and the anti-skid pad 12 is provided in a ring shape.

In use, vegetables are placed in the dehydration basket 3, and the knob 9 is twisted. The teeth of the center gear 803 cannot be meshed with the driven gear 805 within the twisted range of the knob 9 because the rotation of the sector gear 804 makes the driving gear 806 rotate and forces the driven gear 805 away from the center gear 803 based on the shape of the slotted groove 809, and the dehydration basket 3 will not rotate. After hands are released, the knob 9 is reversely rotated when being pulled by the tension spring 802, so that the teeth of the center gear 803 are meshed with the driven gear 805, since the rotation of the sector gear 804 makes the driving gear 806 rotate reversely and therefore forces the driven gear 805 to move to the center gear 803 based on the shape of the slotted groove 809 such that the center gear 803 meshes with the driven gear 805, to drive the center gear 803 to rotate.

In one embodiment, the present invention is superior to the existing dehydration basket in that the speed of the dehydration basket 3 can be increased. The speed of the dehydration basket 3 can be increased by twisting the knob 9 many times.

After the dehydration of vegetables is completed, wait for the dehydration basket 3 to stop rotating automatically, or the pressing rod 1101 is manually pressed. The friction between the bottom end of the pressing rod 1101 and the separator plate 4 is increased to stop the dehydration basket 3 from rotating. The device is small in size, light in weight, convenient to operate, and suitable for use when being carried out.

Although embodiments of the present invention have been shown and described, it will be understood by those skilled in the art that various changes, modifications, substitutions and variations can be made to these embodiments without departing from the principle and spirit of the present invention. The scope of the present invention is defined by the appended claims and the equivalents thereof.

What is claimed is:

1. A vegetable dehydrator, comprising:
a barrel body;
a dehydration basket;
a separator plate;
a limiting protrusion;
a limiting groove;
a buckle fixed on an upper surface of the separator plate;
a driving mechanism;
an upper cover;
a knob rotatably connected in the upper cover; and
a hook fixed on an outer wall of the knob, wherein:
the upper cover is detachably engaged with a top of the barrel body;
the dehydration basket and the separator plate are provided between the barrel body and the upper cover;
a top of the dehydration basket is clamped and fixed with the separator plate;
a center of an inner bottom surface of the barrel body is provided with the limiting protrusion which supports and makes the dehydration basket to rotate freely on a tip of the limiting protrusion;
a bottom of the dehydration basket is provided with the limiting groove into which the limiting protrusion is inserted; and
the driving mechanism is provided below the upper cover;
wherein the driving mechanism comprises:
an installation disk;
a tension spring; and
a center gear, wherein:
the installation disk is fixed below the upper cover;
the buckle is coaxially attached to the center gear;
one end of the tension spring is fixedly connected with an inner wall of the installation disk; and
the other end of the tension spring is hooked with the hook;
wherein the knob is configured to be twisted such that the tension spring is stretched, and
when the knob is released, the driving mechanism is configured to rotate the buckle by pulling force of the tension spring, thereby rotating the dehydration basket.

2. The vegetable dehydrator according to claim 1, wherein the driving mechanism further comprises:
a sector gear;
a driving gear; and
a driven gear, wherein:
the sector gear is coaxially attached to a bottom of the knob;
the driving gear is meshed with the sector gear; and
the driven gear and the driving gear are coaxially attached to each other.

3. The vegetable dehydrator according to claim 2, wherein the driving mechanism further comprises a slotted groove wherein the slotted groove is a longitudinal slot configured to receive a common axle penetrating through a center of the driven gear and the driving gear so that the driving gear and the driven gear can slide along the slotted groove.

4. The vegetable dehydrator according to claim 3, wherein the knob is configured to be twisted such that the rotation of the sector gear makes the driving gear rotate and forces the driven gear away from the center gear based on the shape of the slotted groove and the center gear does not mesh with the driven gear; wherein the knob is configured to be released such that the rotation of the sector gear makes the driving gear rotate reversely and therefore forces the driven gear to move to the center gear based on the shape of the slotted groove and the center gear meshes with the driven gear;
whereby the driving mechanism is configured to rotate the buckle and the dehydration basket when the knob is released and the driving mechanism is configured not to rotate the buckle and the dehydration basket when the knob is twisted.

5. The vegetable dehydrator according to claim 1, wherein the knob is configured to be twisted to any degree and released.

6. The vegetable dehydrator according to claim 5, wherein the knob is configured to be twisted any degree up to 120 degrees and released.

7. The vegetable dehydrator according to claim 5, wherein the knob is configured to be twisted any degree up to 90 degrees and released.

8. The vegetable dehydrator according to claim 5, wherein the knob is configured to be twisted any degree up to 60 degrees and released.

9. The vegetable dehydrator according to claim 2, wherein the driving mechanism further comprises:
a limiting plunger; and
a stopper wherein:
The stopper is configured to block the limiting plunger from moving beyond the stopper;
the limiting plunger is fixed on one side of the hook; and
the stopper is provided on a lower surface of the upper cover.

10. The vegetable dehydrator according to claim 9, wherein the stopper blocks the limiting plunger from moving beyond a certain angle.

11. The vegetable dehydrator according to claim 10, wherein the certain angle is 120 degrees or less.

12. The vegetable dehydrator according to claim 10, wherein the certain angle is 90 degrees or less.

13. The vegetable dehydrator according to claim 3, wherein the vegetable dehydrator further comprises a brake structure comprising:
a pressing rod;
a limiting convex ring fixed on an outer wall of one end of the pressing rod; and
a limiting cylinder fixed in the installation disk, wherein:
the pressing rod penetrates through the upper cover; and
the pressing rod is inserted into the limiting cylinder and penetrates through the installation disk;
wherein the dehydration basket is configured to stop rotating by friction between the separator plate and a bottom end of the pressing rod when the pressing rod is pressed.

14. The vegetable dehydrator according to claim 13, wherein a top of the pressing rod is provided in a hemispherical shape and an upper surface of the upper cover is provided with a through hole through which the top of the pressing rod penetrates.

15. The vegetable dehydrator according to claim 1, wherein the vegetable dehydrator further comprises an anti-skid pad fixed at the bottom of the barrel body.

16. The vegetable dehydrator according to claim 15, wherein the anti-skid pad is provided in a ring shape.

17. The vegetable dehydrator according to claim 13, wherein the brake structure is provided in the upper cover.

18. The vegetable dehydrator according to claim 4, wherein the center gear is configured to push the driven gear away from the center gear based on the shape of the slotted groove after the knob is released and rotated reversely, thereby the center gear does not mesh with the driven gear and the dehydration basket can continue to freely rotate by inertia, thus prolonging hydro-extracting time.

19. The vegetable dehydrator according to claim 4, wherein the knob is configured to be twisted and released during a free rotation of the dehydration basket that the rotation of the sector gear makes the driving gear rotate reversely and therefore forces the driven gear to move to the center gear based on the shape of the slotted groove, and the center gear meshes with the driven gear, thereby the rotation of the sector gear makes the center gear and the dehydration basket rotate further.

20. The vegetable dehydrator according to claim 19, wherein the center gear and the rotation basket is configured to rotate further to prolong the duration of the free rotation of the dehydration basket and/or to increase the speed of the free rotation of the dehydration basket.
